(19) United States
(12) Patent Application Publication
(10) Pub. No.: US 2023/0408458 A1
(43) Pub. Date: Dec. 21, 2023

(54) ROTARY FOR ROTARY SHEAR VALVE

(71) Applicant: DIONEX SOFTRON GMBH, Gemering (DE)

(72) Inventor: Lukas Lentz, Munich (DE)

(21) Appl. No.: 18/327,833

(22) Filed: Jun. 1, 2023

(30) Foreign Application Priority Data
Jun. 15, 2022 (DE) 10 2022 115133.6

(51) Int. Cl. G01N 30/22

(52) U.S. Cl. CPC G01N 30/22; G01N 2030/202

(57) ABSTRACT

The present invention relates to a rotor for a rotary shear valve, the rotor comprising a rotor sealing surface and a compensating element, as well as to a rotor assembly for a rotary shear valve, the rotor assembly comprising a rotor according to any of the preceding rotor embodiments and a rotor receptacle configured to receive the rotor, wherein the rotor is connected to the rotor receptacle in a rotationally fixed manner. Furthermore, the present invention also relates to a rotary shear valve comprising a rotor comprising a compensating element, a rotor receptacle configured to receive the rotor, a stator and a drive unit.

### CROSS-REFERENCE TO RELATED APPLICATIONS

This application claims the priority benefit under 35 U.S.C. § 119 to German Patent Application No. DE102022115133.6 [Attorney Docket No. TP118328DEPRI1], filed on Jun. 15, 2022, the disclosure of which is incorporated herein by reference in its entirety.

### FIELD OF THE DISCLOSURE

The present invention generally relates to rotatable shear valves, and more particularly to the rotor of a rotatable shear valve.

### BACKGROUND

The present invention is described with a particular focus on rotatable shear valves for liquid chromatography (LC) and more particularly high performance liquid chromatography (HPLC). HPLC, and more generally liquid chromatography, is a method of separating samples into their constituent parts, which can be detected and quantified and/or their portions can be stored for subsequent use. In other words, the present invention may particularly be utilized in the field of LC and/or HPLC. However, it will be understood that the present technology may also be used in the context of other applications that require the use of respective shear valves.

Current shear valves in HPLC often utilize a metallic component (i.e. a stator) and a rotor composed of polymeric material. These two components form a substantially liquid-tight stator-rotor interface. Such an interface may also be referred to as “hard-on-soft” sealing surface. Thus, embodiments of the present invention may relate to shear valves with so called “hard-on-soft” sealing surface.

Generally, the increasing demands on shear valves concern an increasingly long service life of the components, an increasing operating pressure and the use of numerous solvents. These requirements arise in the context of additionally intensifying cost pressure—more robust valves at lower manufacturing costs.

Known stators typically comprises a stator surface and at least two stator ports that are fluidly connected to the stator surface. In other words, such a stator may comprise a substantially planar stator surface and at least two stator channels that connect to the stator surface at the stator ports. Thus, each stator channel may run through the stator and provide a fluid connection between the stator surface and the respective port, which may typically be located on a portion of the stator lying opposite to the stator surface. The stator surface may essentially consist of a metallic or ceramic material.

The rotor of known shear valves comprises a substantially planar rotor surface comprising one or more grooves, e.g. channels. These grooves may generally be configured such that in an assembled state, the shear valve may assume configurations wherein the at least one groove fluidly connects at least two stator ports. The rotor surface may essentially consist of a plastic or filled plastic.

Generally, known shear valves may comprise a tribological coating on at least one of the rotor surface and the stator surface.

When assembled, the rotor and stator can rotate relative to each other to realize at least two different valve configurations (relative positions of rotor and stator), wherein each of the at least two stator ports may for example be fluidly connected to another stator port or sealed to the rotor surface. That is, a rotor assembly is mounted for rotation about an axis such that relative movement between the rotor surface and the stator surface is possible in a liquid-tight manner at the rotor-stator interface, realizing two or more rotor positions. In other words, the shear valve may be configured to switch between at least to valve or respectively rotor positions in a liquid-tight manner.

To achieve liquid-tight switching of the valve, the stator and rotor are pressed against each other with a sealing pressure at least equal to the liquid pressure. That is, the pressure of the liquid being provided at at least one port of the stator. Consequently, at high liquid pressure a high sealing pressure is used which can negatively influence the service life of the rotor and the stator. To enable the liquid-tight relative movement between two or more rotor positions, the stator and rotor are mounted and guided plane-parallel to each other. Otherwise, possible manufacturing tolerances or tilting of the rotor relative to the stator due to operation lead to excessive stresses, which may cause rapid wear, especially at high sealing pressure, or compromise the tightness of the valve. In other words, in order to achieve the sealing pressure for liquid-tight operation of the valve, a corresponding sealing force is used. To achieve an optimal sealing effect, the sealing force should act perpendicularly and centrally to the sealing surface at the stator-rotor interface.

In other words, any tilting of the rotor relative to the stator leads to punctually increased load peaks on the sealing surface i.e. the common contact surface between stator and rotor, and thus again to punctual wear, which may subsequently spread to the entire sealing surface. Thus, tilting of the rotor has to be avoided and/or corrected for.

To counteract a tilting of the rotor, a number of compensating elements are currently known. These compensate for tilting through different modes of operation. However, while known solutions compensate for a tilting of the rotor to the stator, the sealing force disadvantageously no longer acts centrally on the sealing surface. This results in one-sided excess stress on the stator and rotor and thus promotes premature wear. Furthermore, current compensating elements are usually provided through additional components. The production of these additional components generally renders the valves more complex and thus increases the costs. In addition, also the assembly of multi-part compensating elements is more complex and expensive.

For example, US 2014/0042349 A1 discloses a switching valve including a stator and a rotor. The stator includes multiple connection ports and the rotor has predetermined switching positions and interacts with the stator to form a fluidic connection or a fluidic disconnection of predetermined connection ports. The rotor can be mounted rotatably via a bearing and pressing device loaded with a predefined pressing force in a direction of the stator. The bearing and pressing device includes a compensation element to load the rotor and transmit the pressing force. The compensation element is configured to make an elastic flexural deformation so that the compensation element loads the rotor when the rotor is wobbling with respect to an axis of rotation. In particular, a wobble bar is disclosed as compensation element. Thus, the disclosed solution requires additional components, which renders the shear valve and its production more complicated and complex, leading to a negative impact on the costs of manufacturing and assembly. Furthermore, this solution is particularly designed for hard-on-hard valves, i.e. valves where both stator and rotor surfaces are made of hard materials such as metal or ceramic.

DE 10 2021 119 759 A1 discloses a flow element in a high-performance chromatography system for separating components of a sample liquid introduced into a mobile phase. The flow element comprises a flow path configured to transport the mobile phase and a sealing structure which is or can be connected to the mobile phase in order to bring about a fluidic seal of the flow path under the influence of a pressure of the mobile phase. The sealing structure is configured in such a way that, under the influence of the pressure of the mobile phase, there is an at least partial increase in volume of the sealing structure, which seals the flow path. In other words, a highly complex compensation system is disclosed in this document, which varies and adjusts the sealing pressure depending on the fluid pressure of the analysis run. However, such a system uses a plurality of parts that are demanding in terms of production technology, which in turn render the flow element complex and thus expensive. Further, the expenditure required to realize the disclosed flow element is disproportionate to the aim of providing a rotary valve with reduced wear with a strong sealing effect in order to increase service life of the valve for the user (i.e. less replacement of wearing parts such as the rotor seal.

In U.S. Pat. No. 9,303,775 B2 rotary shear valves including a stator, a rotor defining a cavity extending at least partially therethrough, and a bladder are disclosed. The rotor is rotatably mounted relative to the stator to create at least one fluidic path therebetween and the bladder comprises a polymer disposed inside the cavity. In other words, a bladder is filled with a polymer and the sealing surface is provided via a membrane, which is supposed to seal the sealing surface evenly. However, again such a design requires additional, very complex components having a negative impact on the cost of manufacturing and assembly. Furthermore, the lifespan of such a concept is not ideal, as the membrane appears susceptible to wear and small defects may jeopardise the integrity of the bladder.

US 2011/006237 A1 and similarly WO 2011/008657 A2 discloses a multi-position rotary shear valve assembly having a substantially metallic or ceramic stator device and a substantially metallic or ceramic rotor device. The stator device defines a substantially planar stator face and at least two or more stator channels in fluid communication with the stator face at corresponding stator ports, while the rotor device includes a substantially planar rotor face defining one or more rotor channels. A tribological coating is disposed atop at least one of the rotor face and the stator face, which enables a substantially fluid-tight, selective relative rotation between the rotor face and the stator face, at a rotor-stator interface, between two or more rotor positions. In particular, a ball bearing element is disclosed, which is disposed between a head portion of the rotor assembly and the rotor element and supposed to manage the axial fore transmission of the sealing force without tilting of the rotor surface with respect to the stator surface. However, the disclosed design requires many additional components, which renders the respective valve more complex and thus has a negative impact on costs of manufacturing and assembly. Furthermore, the point of force application it not in the centre of the sealing surface due to the relative tilt of the rotor assembly to the rotor element. Again, also this design is particularly disclosed for hard-on-hard shear valves.

In light of the above, it is an object to overcome or at least alleviate the shortcomings and disadvantages of the prior art. More particularly, it is an object of the present invention to provide a less complex compensating element.

These objects are met by the present invention.

In a first embodiment, the present invention relates to a rotor for a rotary shear valve, the rotor comprising a rotor sealing surface and a compensating element.

The compensating element may be integrally formed with at least one other portion of the rotor. That is, the compensating element may not be formed as an individual component, but instead be integral to at least a portion of the rotor.

The compensating element may be permanently connected to at least one other portion of the rotor. For example, the compensating element may be glued to, injection moulded to, welded to or integrally formed with another portion of the rotor. The compensating element may be injection moulded to at least one other portion of the rotor. In some embodiments, the rotor may be integrally formed. That is, in particular the rotor sealing surface and the compensating element may be integrally formed.

That is, in some embodiments, the present invention provides a rotor already comprising a compensating element. Thus, there is no requirement for additional components to realise a compensation mechanism and complexity of a valve utilizing such a rotor can therefore advantageously be reduced. That is, the present invention provides a simple and inexpensive compensating element which is part of the rotor. In other words, the function of the compensating element is integrated into the rotor. This avoids additional components, reducing the complexity of a valve utilizing such a rotor, and saves costs.

Furthermore, the compensating element according to the present invention may enable an advantageous force flow which in turns reduces tilting and excessive stresses and thus increases the service life of the valve. In particular, the compensating element may allow to compensate a potential tilt of the rotor relative to the stator such that the force flow acts perpendicular to the sealing surface and the point of force application acts in the centre of the sealing surface. This may advantageously enable a uniform sealing pressure between the rotor and stator, and reduce stress on rotor and stator and consequently optimise their service life.

The rotor may comprise a proximal face and a distal face, wherein the proximal face is opposite to the distal face. The proximal face may comprise the rotor sealing surface. The distal face may comprise the compensating element.

The rotor sealing surface may comprise a rotor sealing surface centre. That is, the rotor sealing surface may comprise a rotor sealing surface centre located at the geometrical centre of the rotor surface

The compensating element may be configured to receive a force. That is, the compensating element may be configured for receiving a force provided to it, for example by means of a drive unit of a valve. The compensating element may be configured to direct the force to the rotor sealing surface centre.

The compensating element may comprise a compensating element centre. Further, the compensating element centre may be aligned with the rotor sealing surface centre. That is, the compensating element centre and the rotor sealing surface centre may lie on a straight line perpendicular to the rotor sealing surface.

The compensating element may be rotationally symmetric around an element rotation axis. Further, the element rotation axis may run through the rotor sealing surface centre. Again, the compensating element and the rotor sealing surface would thus be aligned with respect to each other such that the rotor sealing surface centre lies on the element rotation axis of the compensating element.

The compensating element may comprise an element radius corresponding to half of a maximum extension of the compensating element perpendicular to the element rotation axis. That is, the radius may correspond to half of the maximum visible extension of the compensating element. The element radius may be in the range of 1 to 5 mm, preferably 2 to 4 mm, more preferably 2.5 to 3 mm, such as 2.55 mm.

The compensating element may be dome shaped. The compensating element may comprise the form of a spherical cap, wherein the spherical cap preferably comprises a sphere radius that describes a curvature of the compensating element. The sphere radius may amount at least to a distance between the rotor sealing surface and the most distal point of the compensating element. In some embodiments, the sphere radius amounts to the distance between the rotor sealing surface and the most distal point of the compensating element. That is, the sphere radius may correspond to a thickness of the rotor at the centre of the compensating element. The sphere radius may be in the range of 8 to 12 mm, preferably 9 to 11 mm, more preferably 9.9 to 10.1 mm.

It is noted that in case of the compensating comprising the form of a spherical cap, the element radius may also be referred to as cap radius and it may correspond to the radius of the base of the spherical cap. The element radius may be smaller than the sphere radius.

The rotor sealing surface may be rotationally symmetric around a surface rotation axis. Further, the surface rotation axis may run through the compensating element centre. The rotor sealing surface may comprise a surface radius. The surface radius may be in the range of 1 to 6 mm, preferably 2 to 5 mm, more preferably 3 to 4 mm.

The rotor sealing surface may comprise at least one connecting element configured to provide a fluid connection between ports of a stator of the rotary shear valve. The at least one connecting element may be at least one groove in the rotor sealing surface.

The rotor may be disk-shaped. More generally, the rotor may generally be rotationally symmetric. It should be understood that the rotor may be generally rotationally symmetric, e.g., rotationally symmetric with the exception of grooves. The rotor may comprise a rotor radius, wherein the rotor radius may be in the range of 5 to 15 mm, preferably 6 to 10 mm, more preferably 7 to 9 mm, such as 8 mm.

The rotor may be made of metal, ceramic, or a polymer. In some embodiments, the rotor may be made of titan or stainless steel. Alternatively, the rotor may be of a polymer. In particular, the rotor may be made of a particulate-filled polymer or a fibre-reinforced polymer. Generally, the rotor surface may be coated with a tribological coating.

The rotor may comprise a plurality of bores and/or recesses configured to receive a connecting bolt.

The rotor sealing surface may comprise a sealing surface roughness of at most 1 μm Ra, preferably at most 0.6 μm Ra, more preferably at most 0.4 μm Ra. It will be understood that Ra refers to the average roughness of the surface. The compensating element may comprise an element surface roughness of at most 1 am Ra, preferably at most 0.6 μm Ra, more preferably at most 0.4 μm Ra. The rotor sealing surface may comprise a sealing surface flatness of less than 10 μm, preferably less than 5 μm, more preferably less than 1 μm.

The rotor may be configured for pressures of at least up to 100 bar, preferably at least up to 500 bar, more preferably at least up to 1500 bar. In other words, the rotor may be configured for operating pressures of up to 100 bar, preferably at least up to 500 bar, more preferably at least up to 1500 bar.

The complete rotor may be formed as a single piece of material.

The rotor may comprise a thickness in the range of 2 to 10 mm, preferably 2 to 6 mm, more preferably 3 to 5 mm, such as 4 mm. It should be understood that the thickness is the extension of the rotor between its proximal end and distal end.

In another embodiment, the present invention relates to a rotor assembly for a rotary shear valve, the rotor assembly comprising a rotor according to the present invention as described above and a rotor receptacle configured to receive the rotor.

The rotor may be connected to the rotor receptacle in a rotationally fixed manner.

The rotor receptacle may comprise a proximal receptacle face. The rotor may be connected to the rotor receptacle such that the distal face of the rotor is adjacent to the proximal receptacle face.

The rotor receptacle may comprise a contacting portion, configured to contact and interact with the compensating element of the rotor. The contacting portion may be comprised by the proximal receptacle face. The contacting portion may comprise a contacting portion centre. The contacting portion centre may be aligned with the rotor sealing surface centre.

Additionally or alternatively, the contacting portion centre may be aligned with the compensating element centre.

The rotor assembly may be configured to enable the rotor to tilt with respect to the rotor receptacle. The rotor may be enabled to tilt by a polar angle at least in the range of 0° to 1°, preferably at least in the range of 0° to 2° with respect to the rotor receptacle. The polar angle being the angle relative to an axis running through the compensating element centre. In particular, the rotor may be enabled to tilt by any azimuthal angle.

The contacting portion may be a protrusion of the proximal receptacle face. The contacting portion may comprise the most proximal portion of the rotor receptacle.

The contacting portion may comprise a contacting surface. The contacting surface may be in contact with the compensating element. The contacting surface may be substantially flat. The contacting surface may comprise a contacting surface flatness of less than 10 μm, preferably less than 5 μm, more preferably less than 1 am. Alternatively, the contacting surface may comprise a dome-shaped indentation. A curvature of the dome-shaped indentation may be less or equal to a curvature of the compensating element.

The contacting surface may comprise a contacting surface roughness of at most 1 μm Ra, preferably at most 0.6 μm Ra, more preferably at most 0.4 μm Ra.

The contacting surface may be circularly shaped. The contacting surface may comprise a contacting surface radius. The contacting surface radius may be in the rage of 0.5 to 5 mm, preferably 1 to 2.5 mm. The contacting surface radius may be equal to or greater than the element radius.

The contacting portion may comprise a portion width. It will be understood that the portion width corresponds to the maximum extend of the portion in a direction perpendicular to the proximal to distal direction. The portion width may be at least equal to twice the element radius. The portion width may be in the rage of 1 to 10 mm, preferably 1 to 5 mm.

The contacting portion may be rotationally symmetric.

The rotor assembly may be configured to receive a force at the rotor receptacle and direct the force to the rotor sealing surface via the contacting portion and the compensating element. The rotor assembly may be configured to direct the force to the rotor sealing surface centre. The rotor assembly may be configured to direct at least 99%, preferably at least 99.5%, more preferably 99.9% of the force to the rotor sealing surface solely via the contacting portion and the compensating element. The rotor assembly may be configured to direct the axial force to the rotor sealing surface solely via the contacting portion and the compensating element. The axial force denotes the portion of the force that is directed along the axial direction of the rotor, i.e. the force component that is directed perpendicular to the rotor sealing surface.

The rotor receptacle may comprise a plurality of connecting bolts configured to be received by the respective bores and/or recesses of the rotor. The rotor may be connected to the rotor receptacle in a rotationally fixed manner by means of the connecting bolts. The connecting bolts, and/or the bores and/or recesses in the rotor may be configured to allow a relative tilt of the rotor with respect to the rotor receptacle. The number of bores and/or recesses of the rotor may match the number of the plurality of connecting bolts. The plurality of connecting bolts may be 2, 3, 4 or 5 connecting bolts.

The rotor receptacle may comprise a plurality of bores and/or recesses configured to receive the respective connecting bolts. The number of bores and/or recesses of the rotor receptacle may match the number of the plurality of connecting bolts.

The plurality of connecting bolts may be integrally formed with the rotor receptacle.

In a further embodiment, the present invention relates to a rotary shear valve comprising a rotor comprising a compensating element, a rotor receptacle configured to receive the rotor, a stator, and a drive unit.

The rotor may be a rotor according to0 the present invention as described above. The rotor and the rotor receptacle may be comprised by a rotor assembly according to the present invention as described above. That is rotor and rotor receptacle of the rotary shear valve may form a rotor assembly comprising any of the respective features described above.

The stator may comprise a stator sealing surface. The stator sealing surface may comprise a stator sealing surface roughness of at most 1 μm Ra, preferably at most 0.6 μm Ra, more preferably at most 0.4 μm Ra.

The stator may comprise a proximal stator face and a distal stator face, wherein the proximal face is opposite to the distal face. The distal stator face may comprise the stator sealing surface.

The rotor may be located adjacent to and distal of the stator, such that rotor and stator form a rotor-stator interface. The rotor-stator interface may be formed by the rotor sealing surface and the stator sealing surface. The rotor-stator interface may comprise a residual leak rate of up to 500 nl/min, preferably up to 100 nl/min, more preferably up to 50 nl/min at operating pressure. That is, the leak rate may hold for any pressure within the operating pressure range of the valve, e.g. up to 100 bar, preferably up to 500 bar, more preferably up to 1000 bar even more preferably up to 1500 bar.

The rotor-stator interface comprises a residual leak rate of at least 10 nl/min. This may advantageously ensure sufficient lubrication of the rotor-stator interface.

The rotor may be received by the rotor receptacle in a rotationally fixed manner. That is, the rotor may be received such that, when the rotor receptacle rotates due to a rotational force, the rotor also rotates simultaneously as the connection between the rotor and the rotor receptacle may be rotationally fixed.

The rotor receptacle may be received by the drive unit. The drive unit may be configured to provide a rotational force to rotate the rotor relative to the stator via the rotor receptacle.

The valve may be configured to exert an axial force on the rotor. That is, it may provide a force acting along a rotation axis of the rotational force provided for rotating the rotor via the rotor receptacle. The drive unit may be configured to provide the axial force. Generally, the valve may comprise at least one biasing element configured to bias the rotor receptacle towards the stator. In particular, the biasing element may be configured to provide the axial force. The drive unit may comprise the biasing element.

The at least one biasing element may be a spring element, preferably an annular spring element. The biasing element may be configured to supply a force sufficient to provide a pressure of at least 100 bar, preferably at least 500 bar, more preferably at least 1500 bar at the stator-rotor interface.

The stator may comprise at least two ports. The at least two ports may be located in the proximal stator face. The at least 2 ports may be provided as fittings for receiving a respective connector. Each of the at least 2 ports may be fluidly connected to the stator sealing surface.

The valve may further comprise a fixation means interconnecting different valve components. The stator may be fixedly mounted to the fixation means. Further, the stator may be fixed to the fixation means by means of screws or bolts. The drive unit may be fixedly mounted to the fixation means. The fixation means may be a screw-in flange. The drive unit may be fixedly mounted to the screw-in flange by means of a thread comprised by the drive unit and received by a respective thread of the screw-in flange. Stator and drive unit may respectively be mounted to opposing sides of the fixation means.

The at least one connecting element of the rotor may be configured to establish a fluid connection between ports of the stator depending on a relative position of stator and rotor. The valve may be configured to assume different configurations, wherein for each different configuration the relative position of stator and rotor differs. The at least one connecting element of the rotor may be configured to changeably fluidly connect different ports of the stator depending on a configuration assumed by the valve.

The valve may further comprise a controller configured to control the drive unit. The controller may comprise a data processing unit. The controller may be configured to control the drive unit such that the valve assumes a desired configuration.

The valve may be configured for an operating pressure of at least up to 100 bar, preferably at least up to 500 bar, more preferably at least up to 1500 bar. The biasing element may be configured to supply a force sufficient to provide a pressure of at least 105% of the operating pressure, preferably at least 110% of the operating pressure at the stator-rotor interface.

The rotor and the stator may be guided plane-parallel to each other when rotating the rotor.

The stator sealing surface may comprise a stator sealing surface flatness of less than 10 μm, preferably less than 5 μm, more preferably less than 1 μm.

In another embodiment the present invention relates to a use of the rotor according to the present invention as described above, of the rotor assembly according to the present invention as described above, or of the shear valve according to the present invention as described above for selectively controlling a fluid flow.

The use may be in chromatography. Further, the use may be in liquid chromatography. Yet further, the use may be in high performance liquid chromatography. Further, the use may be in ultra-high performance liquid chromatography.

The use may comprise guiding a fluid with a pressure above 100 bar, preferably above 500 bar, such as above 1,000 bar through the rotor.

In another embodiment the present invention relates to a method of operating a rotary shear valve, the method comprising the steps of providing a shear valve according to any of the preceding valve embodiments, transmitting an axial force to the rotor via the rotor receptacle and the compensating element, wherein the compensating element compensates for a relative tilt between the rotor and the stator. Between the rotor receptacle and the rotor at least 99%, preferably at least 99.5%, more preferably 99.9% of the force may be solely transmitted vie the compensating element. Preferably, between the rotor receptacle and the rotor the axial force may be solely transmitted vie the compensating element.

The method may further comprise applying a rotational force to the rotor receptacle and changing the relative position between rotor and stator.

Transmitting the axial force to the rotor via the rotor receptacle and the compensating element may comprise transmitting the force to the rotor sealing surface centre.

The method may further comprise guiding the rotor and the stator plane-parallel to each other.

Below, reference will be made to rotor embodiments. These embodiments are abbreviated by the letter “R” followed by a number. Whenever reference is herein made to “rotor embodiments”, these embodiments are meant.

R1. A rotor for a rotary shear valve, the rotor comprising
a rotor sealing surface, and
a compensating element.

R2. The rotor according to the preceding rotor embodiment, wherein the compensating element is integrally formed with at least one other portion of the rotor.

R2a. The rotor according to embodiment R1, wherein the compensating element is permanently connected to at least one other portion of the rotor.

R2b. The rotor according to the preceding embodiment, wherein the compensating element is injection moulded to at least one other portion of the rotor.

R3. The rotor according to any of the embodiments R1 or R2, wherein the rotor is integrally formed.

That is, in particular the rotor sealing surface and the compensating element are integrally formed.

R4. The rotor according to any of the preceding rotor embodiments, wherein the rotor comprises a proximal face and a distal face, wherein the proximal face is opposite to the distal face.

R5. The rotor according to the preceding rotor embodiment, wherein the proximal face comprises the rotor sealing surface.

R6. The rotor according to any of the 2 preceding rotor embodiments, wherein the distal face comprises the compensating element.

R7. The rotor according to any of the preceding rotor embodiments, wherein the rotor sealing surface comprises a rotor sealing surface centre.

That is, the rotor sealing surface comprises a rotor sealing surface centre located at the geometrical centre of the rotor surface

R8. The rotor according to any of the preceding rotor embodiments, wherein the compensating element is configured to receive a force.

R9. The rotor according to the preceding rotor embodiment and comprising the features of R7, wherein the compensating element is configured to direct the force to the rotor sealing surface centre.

R10. The rotor according to any of the preceding rotor embodiments, wherein the compensating element comprises a compensating element centre.

R11. The rotor according to the preceding rotor element and with the features of R7, wherein the compensating element centre is aligned with the rotor sealing surface centre.

R12. The rotor according to any of the preceding rotor embodiments, wherein the compensating element is rotationally symmetric around an element rotation axis.

R13. The rotor according to the preceding rotor embodiment and with the features of R7, wherein the element rotation axis runs through the rotor sealing surface centre.

R14. The rotor according to any of the 2 preceding rotor embodiments, wherein the compensating element comprises an element radius corresponding to half of a maximum extension of the compensating element perpendicular to the element rotation axis.

R15. The rotor according to the preceding rotor embodiment, wherein the element radius is in the range of 1 to 5 mm, preferably 2 to 4 mm, more preferably 2.5 to 3 mm, such as 2.55 mm.

R16. The rotor according to any of the preceding rotor embodiments, wherein the compensating element is dome shaped.

R17. The rotor according to any of the preceding embodiments, wherein the compensating element comprises the form of a spherical cap, wherein the spherical cap preferably comprises a sphere radius that describes a curvature of the compensating element.

R18. The rotor according to the preceding rotor embodiment, wherein the sphere radius amounts at least to a distance between the rotor sealing surface and the most distal point of the compensating element.

R19. The rotor according to the preceding rotor embodiment, wherein the sphere radius amounts to the distance between the rotor sealing surface and the most distal point of the compensating element.

That is, the sphere radius may correspond to a thickness of the rotor at the centre of the compensating element.

R20. The rotor according to any of the 3 preceding rotor embodiments, wherein the sphere radius is in the range of 8 to 12 mm, preferably 9 to 11 mm, more preferably 9.9 to 10.1 mm.

It is noted that in case of the compensating comprising the form of a spherical cap, the element radius may also be referred to as cap radius and it may correspond to the radius of the base of the spherical cap.

R21. The rotor according to any of the 4 preceding rotor embodiments and with the features of R14, wherein the element radius is smaller than the sphere radius.

R22. The rotor according to any of the preceding rotor embodiments, wherein the rotor sealing surface is rotationally symmetric around a surface rotation axis.

R23. The rotor according to the preceding rotor embodiment and with the features of R10, wherein the surface rotation axis runs through the compensating element centre.

R24. The rotor according to any of the 2 preceding rotor embodiments, wherein the rotor sealing surface comprises a surface radius.

R25. The rotor according to the preceding rotor embodiment, wherein the surface radius is in the range of 1 to 6 mm, preferably 2 to 5 mm, more preferably 3 to 4 mm.

R26. The rotor according to any of the preceding rotor embodiments, wherein the rotor sealing surface comprises at least one connecting element configured to provide a fluid connection between ports of a stator of the rotary shear valve.

R27. The rotor according to the preceding rotor embodiment, wherein the at least one connecting element is at least one groove in the rotor sealing surface.

R28. The rotor according to any of the preceding rotor embodiments, wherein the rotor is disk-shaped.

R29. The rotor according to any of the preceding rotor embodiments, wherein the rotor is generally rotationally symmetric.

It should be understood that the rotor may be generally rotationally symmetric, e.g., rotationally symmetric with the exception of grooves.

R30. The rotor according to any of the 2 preceding rotor embodiments, wherein the rotor comprises a rotor radius, wherein the rotor radius is in the range of 5 to 15 mm, preferably 6 to 10 mm, more preferably 7 to 9 mm, such as 8 mm.

R31. The rotor according to any of the preceding rotor embodiments, wherein the rotor is made of metal, ceramic, or a polymer.

R32. The rotor according to the preceding rotor embodiment, wherein the rotor is made of titan or stainless steel.

R33. The rotor according to the penultimate rotor embodiment, wherein the rotor is made of a polymer.

R34. The rotor according to the preceding rotor embodiment, wherein the rotor is made of a particulate-filled polymer or a fibre-reinforced polymer.

R35. The rotor according to any of the preceding rotor embodiments, wherein the rotor surface is coated with a tribological coating.

R36. The rotor according to any of the preceding rotor embodiments, wherein the rotor comprises a plurality of bores and/or recesses configured to receive a connecting bolt.

R37. The rotor according to any of the preceding rotor embodiments, wherein the rotor sealing surface comprises a sealing surface roughness of at most 1 μm Ra, preferably at most 0.6 μm Ra, more preferably at most 0.4 μm Ra.

R38. The rotor according to any of the preceding rotor embodiments, wherein the compensating element comprises an element surface roughness of at most 1 μm Ra, preferably at most 0.6 μm Ra, more preferably at most 0.4 μm Ra.

R39. The rotor according to any of the preceding rotor embodiments, wherein the rotor sealing surface comprises a sealing surface flatness of less than 10 μm, preferably less than 5 μm, more preferably less than 1 μm.

R40. The rotor according to any of the preceding rotor embodiments, wherein the rotor is configured for pressures of at least up to 100 bar, preferably at least up to 500 bar, more preferably at least up to 1500 bar.

R41. The rotor according to any of the preceding embodiments, wherein the complete rotor is formed as a single piece of material.

R42. The rotor according to any of the preceding embodiments, wherein the rotor comprises a thickness in the range of 2 to 10 mm, preferably 2 to 6 mm, more preferably 3 to 5 mm, such as 4 mm.

It should be understood that the thickness is the extension of the rotor between its proximal end and distal end.

Below, reference will be made to rotor assembly embodiments. These embodiments are abbreviated by the letter “A” followed by a number. Whenever reference is herein made to “assembly embodiments”, these embodiments are meant.

A1. A rotor assembly for a rotary shear valve, the rotor assembly comprising
a rotor according to any of the preceding rotor embodiments, and
a rotor receptacle configured to receive the rotor.

A2. The rotor assembly according to the preceding assembly embodiment, wherein the rotor is connected to the rotor receptacle in a rotationally fixed manner.

A3. The rotor assembly according to any of the preceding assembly embodiments, wherein the rotor receptacle comprises a proximal receptacle face.

A4. The rotor assembly according to the preceding assembly embodiment and with the features of A2, wherein the rotor comprises the features of R4 and wherein rotor is connected to the rotor receptacle such that the distal face of the rotor is adjacent to the proximal receptacle face.

A5. The rotor assembly according to any of the preceding assembly embodiments, wherein the rotor receptacle comprises a contacting portion, configured to contact and interact with the compensating element of the rotor.

A6. The rotor assembly according to the preceding assembly embodiment and with the features of A3, wherein the contacting portion is comprised by the proximal receptacle face.

A7. The rotor assembly according to any of the 2 preceding assembly embodiments, wherein the contacting portion comprises a contacting portion centre.

A8. The rotor assembly according to any of the preceding assembly embodiment and with the features of R7, wherein contacting portion centre is aligned with the rotor sealing surface centre.

A9. The rotor assembly according to any of the 2 preceding assembly embodiments and with the features of R10, wherein the contacting portion centre is aligned with the compensating element centre.

A10. The rotor assembly according to any of the preceding assembly embodiments, wherein the rotor assembly is configured to enable the rotor to tilt with respect to the rotor receptacle.

A11. The rotor assembly according to the preceding assembly embodiment, wherein the rotor is enabled to tilt by a polar angle at least in the range of 0° to 1°, preferably at least in the range of 0° to 2° with respect to the rotor receptacle.

The polar angle being the angle relative to an axis running through the compensating element centre. In particular, the rotor may be enabled to tilt by any azimuthal angle.

A12. The rotor assembly according to any of the preceding assembly embodiments and with the features of A5, wherein the contacting portion is a protrusion of the proximal receptacle face.

A13. The rotor assembly according to any of the preceding assembly embodiments and with the features of A5, wherein the contacting portion comprises the most proximal portion of the rotor receptacle.

A14. The rotor assembly according to any of the preceding assembly embodiments and with the features of A5, wherein the contacting portion comprises a contacting surface.

A15. The rotor assembly according to the preceding assembly embodiment, wherein the contacting surface is in contact with the compensating element.

A16. The rotor assembly according to the 2 preceding assembly embodiments, wherein the contacting surface is substantially flat.

A17. The rotor assembly according to the preceding assembly embodiments, wherein the contacting surface comprises a contacting surface flatness of less than 10 μm, preferably less than 5 μm, more preferably less than 1 μm.

A18. The rotor assembly according to assembly embodiment A14 or A15, wherein the contacting surface comprises a dome-shaped indentation.

A19. The rotor assembly according to the preceding assembly embodiment, wherein the rotor comprises the features of rotor embodiment R16, wherein a curvature of the dome-shaped indentation is less or equal to a curvature of the compensating element.

A20. The rotor assembly according to the 6 preceding assembly embodiments, wherein the contacting surface comprises a contacting surface roughness of at most 1 μm Ra, preferably at most 0.6 μm Ra, more preferably at most 0.4 μm Ra.

A21. The rotor assembly according to any of the 7 preceding assembly embodiments, wherein the contacting surface is circularly shaped.

A22. The rotor assembly according to the preceding assembly embodiment, wherein the contacting surface comprises a contacting surface radius.

A23. The rotor assembly according to the preceding assembly embodiment, wherein the contacting surface radius is in the rage of 0.5 to 5 mm, preferably 1 to 2.5 mm.

A24. The rotor assembly according to any of the 2 preceding assembly embodiments and with the features of R14, wherein the contacting surface radius is equal to or greater than the element radius.

A25. The rotor assembly according to any of the preceding assembly embodiments and with the features of A5, wherein the contacting portion comprises a portion width.

It will be understood that the portion width corresponds to the maximum extend of the portion in a direction perpendicular to the proximal to distal direction.

A26. The rotor assembly according to the preceding assembly embodiment and with the features of R14, wherein the portion width is at least equal to twice the element radius.

A27. The rotor assembly according to any of the 2 preceding assembly embodiments, wherein the portion width is in the rage of 1 to 10 mm, preferably 1 to 5 mm.

A28. The rotor assembly according to any of the preceding assembly embodiments and with the features of A5, wherein the contacting portion is rotationally symmetric.

A29. The rotor assembly according to any of the preceding assembly embodiments and with the features of A5, wherein the rotor assembly is configured to receive a force at the rotor receptacle and direct the force to the rotor sealing surface via the contacting portion and the compensating element.

A30. The rotor assembly according to the preceding assembly embodiment, wherein the rotor comprises the features of R7 and wherein the rotor assembly is configured to direct the force to the rotor sealing surface centre.

A31. The rotor assembly according to any of the 2 preceding assembly embodiments, wherein the rotor assembly is configured to direct at least 99%, preferably at least 99.5%, more preferably at least 99.9% of the force to the rotor sealing surface solely via the contacting portion and the compensating element.

A32. The rotor assembly according to any of the 3 preceding assembly embodiments, wherein the rotor assembly is configured to direct the axial force to the rotor sealing surface solely via the contacting portion and the compensating element.

A33. The rotor assembly according to any of the preceding assembly embodiments and with the features of R36, wherein the rotor receptacle comprises a plurality of connecting bolts configured to be received by the respective bores and/or recesses of the rotor.

A34. The rotor assembly according to the preceding assembly embodiment and with the features of A2, wherein the rotor is connected to the rotor receptacle in a rotationally fixed manner by means of the connecting bolts.

A35. The rotor assembly according to any of the 2 preceding assembly embodiments, wherein the connecting bolts, and/or the bores and/or recesses in the rotor are configured to allow a relative tilt of the rotor with respect to the rotor receptacle.

A36. The rotor assembly according to any of the 3 preceding assembly embodiments, wherein the number of bores and/or recesses of the rotor matches the number of the plurality of connecting bolts.

A37. The rotor assembly according to any of the 4 preceding assembly embodiments, wherein the plurality of connecting bolts is 2, 3, 4 or 5 connecting bolts.

A38. The rotor assembly according to any of the 5 preceding assembly embodiments, wherein the rotor receptacle comprises a plurality of bores and/or recesses configured to receive the respective connecting bolts.

A39. The rotor assembly according to the preceding assembly embodiment, wherein the number of bores and/or recesses of the rotor receptacle matches the number of the plurality of connecting bolts.

A40. The rotor assembly according to any of assembly embodiments A33 to A37, wherein the plurality of connecting bolts are integrally formed with the rotor receptacle.

Below, reference will be made to shear valve embodiments. These embodiments are abbreviated by the letter “V” followed by a number. Whenever reference is herein made to “valve embodiments”, these embodiments are meant.

V1. A rotary shear valve comprising
a rotor comprising a compensating element,
a rotor receptacle configured to receive the rotor,
a stator, and
a drive unit.

V2. The valve according to the preceding valve embodiment, wherein the rotor is a rotor according to any of the preceding rotor embodiments.

V3. The valve according to any of the preceding valve embodiments, wherein the rotor and the rotor receptacle are comprised by a rotor assembly according to any of the preceding assembly embodiments.

That is rotor and rotor receptacle of the rotary shear valve form a rotor assembly comprising the features of any of the preceding assembly embodiments.

V4. The valve according to any of the preceding valve embodiments, wherein the stator comprises a stator sealing surface.

V5. The valve according to any of the preceding valve embodiments, wherein the stator sealing surface comprises a stator sealing surface roughness of at most 1 μm Ra, preferably at most 0.6 μm Ra, more preferably at most 0.4 μm Ra.

V6. The valve according to any of the preceding valve embodiments wherein the stator comprises a proximal stator face and a distal stator face, wherein the proximal face is opposite to the distal face.

V7. The valve according to the preceding valve embodiment and with the features of V4, wherein the distal stator face comprises the stator sealing surface.

V8. The valve according to any of the preceding valve embodiments, wherein the rotor is located adjacent to and distal of the stator, such that rotor and stator form a rotor-stator interface.

V9. The valve according to the preceding valve embodiment with the features of V2 or V3, and V4, wherein the rotor-stator interface is formed by the rotor sealing surface and the stator sealing surface.

V10. The valve according to any of the 2 preceding valve embodiments, wherein the rotor-stator interface comprises a residual leak rate of up to 500 nl/min, preferably up to 100 nl/min, more preferably up to 50 nl/min at operating pressure.

V11. The valve according to any of the preceding valve embodiments, wherein the rotor is received by the rotor receptacle in a rotationally fixed manner.

V12. The valve according to any of the preceding valve embodiments, wherein the rotor receptacle is received by the drive unit.

V13. The valve according to any of the preceding valve embodiments, wherein the drive unit is configured to provide a rotational force to rotate the rotor relative to the stator via the rotor receptacle.

V14. The valve according to any of the preceding valve embodiments, wherein the valve is configured to exert an axial force on the rotor.

That is, it may provide a force acting along a rotation axis of the rotational force provided for rotating the rotor via the rotor receptacle.

V15. The valve according to the preceding valve embodiment, wherein the drive unit is configured to provide the axial force.

V16. The valve according to any of the 2 preceding valve embodiments, wherein the valve comprises at least one biasing element configured to bias the rotor receptacle towards the stator.

V17. The valve according to the preceding valve embodiment and with the features of V14, wherein the biasing element is configured to provide the axial force.

V18. The valve according to any of the 2 preceding valve embodiments, wherein the drive unit comprises the biasing element.

V19. The valve according to any of the 3 preceding valve embodiments, wherein the at least one biasing element is a spring element, preferably an annular spring element.

V20. The valve according to any of the 4 preceding valve embodiments and with the features of V8, wherein the biasing element is configured to supply a force sufficient to provide a pressure of at least 100 bar, preferably at least 500 bar, more preferably at least 1500 bar at the stator-rotor interface.

V21. The valve according to any of the preceding valve embodiments, wherein the stator comprises at least two ports.

V22. The valve according to the preceding valve embodiment and with the features of V6, wherein the at least two ports are located in the proximal stator face.

V23. The valve according to any of the 2 preceding valve embodiments, wherein the at least 2 ports are provided as fittings for receiving a respective connector.

V24. The valve according to any of the 3 preceding valve embodiments and with the features of V4, wherein each of the at least 2 ports is fluidly connected to the stator sealing surface.

V25. The valve according to any of the preceding valve embodiments, wherein the valve further comprises a fixation means interconnecting different valve components.

V26. The valve according to the preceding valve embodiment, wherein the stator is fixedly mounted to the fixation means.

V27. The valve according to the preceding valve embodiment, wherein the stator is fixed to the fixation means by means of screws or bolts.

V28. The valve according to any of the 3 preceding valve embodiments, wherein the drive unit is fixedly mounted to the fixation means.

V29. The valve according to any of the 4 preceding valve embodiments, wherein the fixation means is a screw-in flange.

V30. The valve according to the preceding valve embodiment, wherein the drive unit is fixedly mounted to the screw-in flange by means of a thread comprised by the drive unit and received by a respective thread of the screw-in flange.

V31. The valve according to any of the preceding valve embodiments and with the features V26 and V28 wherein stator and drive unit are respectively mounted to opposing sides of the fixation means.

V32. The valve according to any of the preceding valve embodiments, wherein the rotor comprises the features of R26 and the stator comprises the features of V21, wherein the at least one connecting element is configured to establish a fluid connection between ports of the stator depending on a relative position of stator and rotor.

V33. The valve according to any of the preceding valve embodiments, wherein the valve is configured to assume different configurations, wherein for each different configuration the relative position of stator and rotor differs.

V34. The valve according to the preceding valve embodiments, wherein the rotor comprises the features of R26 and the stator comprises the features of V21, wherein the at least one connecting element is configured to changeably fluidly connect different ports of the stator depending on a configuration assumed by the valve.

V35. The valve according to any of the preceding valve embodiments, wherein the valve further comprises a controller configured to control the drive unit.

V36. The valve according to the preceding valve embodiment, wherein the controller comprises a data processing unit.

V37. The valve according to any of the 2 preceding valve embodiments and with the features of V33, wherein the controller is configured to control the drive unit such that the valve assumes a desired configuration.

V38. The valve according to any of the preceding valve embodiments, wherein the valve is configured for an operating pressure of at least up to 100 bar, preferably at least up to 500 bar, more preferably at least up to 1500 bar.

V39. The valve according to any of the preceding valve embodiments and with the features of V8 and V16, wherein the biasing element is configured to supply a force sufficient to provide a pressure of at least 105% of the operating pressure, preferably at least 110% of the operating pressure at the stator-rotor interface.

V40. The valve according to any of the preceding valve embodiments, wherein the rotor and the stator are guided plane-parallel to each other when rotating the rotor.

V41. The valve according to any of the preceding valve embodiments, wherein the stator sealing surface comprises a stator sealing surface flatness of less than 10 μm, preferably less than 5 μm, more preferably less than 1 μm.

V42. The valve according to any of the preceding valve embodiments and with the features of V8, wherein the rotor-stator interface comprises a residual leak rate of at least 10 nl/min.

Below, reference will be made to use embodiments. These embodiments are abbreviated by the letter “U” followed by a number. Whenever reference is herein made to “use embodiments”, these embodiments are meant.

U1. Use of the rotor according to any of the preceding rotor embodiments, of the rotor assembly according to any of the preceding assembly embodiments, or of the shear valve according to any of the preceding shear valve embodiments for selectively controlling a fluid flow.

U2. Use according to the preceding use embodiment in chromatography.

U3. Use according to the preceding use embodiment in liquid chromatography.

U4. Use according to the preceding use embodiment in high performance liquid chromatography.

U5. Use according to the preceding use embodiment in ultra-high performance liquid chromatography.

U6. Use according to any of the preceding use embodiments, wherein the use comprises guiding a fluid with a pressure above 100 bar, preferably above 500 bar, such as above 1,000 bar through the rotor.

Below, reference will be made to method embodiments. These embodiments are abbreviated by the letter “M” followed by a number. Whenever reference is herein made to “method embodiments”, these embodiments are meant.

M1. Method of operating a rotary shear valve, comprising:
providing a shear valve according to any of the preceding valve embodiments,
transmitting an axial force to the rotor via the rotor receptacle and the compensating element,
wherein the compensating element compensates for a relative tilt between the rotor and the stator.

M2. The method according to the preceding method embodiment, wherein between the rotor receptacle and the rotor at least 99%, preferably at least 99.5%, more preferably at least 99.9% of the force is solely transmitted vie the compensating element.

M3. The method according to any of the preceding method embodiments, wherein between the rotor receptacle and the rotor the axial force is solely transmitted vie the compensating element.

M4. The method according to any of the preceding method embodiments, wherein the method further comprises applying a rotational force to the rotor receptacle and changing the relative position between rotor and stator.

M5. The method according to any of the preceding method embodiments, wherein the rotor of the shear valve comprises the features of R7 and wherein transmitting the axial force to the rotor via the rotor receptacle and the compensating element comprises transmitting the force to the rotor sealing surface centre.

M6. The method according to any of the preceding method embodiments, further comprising guiding the rotor and the stator plane-parallel to each other.

### BRIEF DESCRIPTION OF THE DRAWINGS

Embodiments of the present invention will now be described with reference to the accompanying drawings. These embodiments should only exemplify, but not limit, the present invention.

FIG. 1 schematically depicts a compensation mechanism according to the state of the art;

FIG. 2 schematically depicts a rotor according to the present invention;

FIG. 3 schematically depicts a rotor assembly according to the present invention;

FIG. 4 schematically depicts a rotatable shear valve according to the present invention;

FIG. 5 schematically depicts a rotatable shear valve according to the present invention compensating a tilt; and

FIG. 6 showing the effect of a tilting element on the wear of a rotor.

### BRIEF DESCRIPTION OF THE DRAWINGS

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

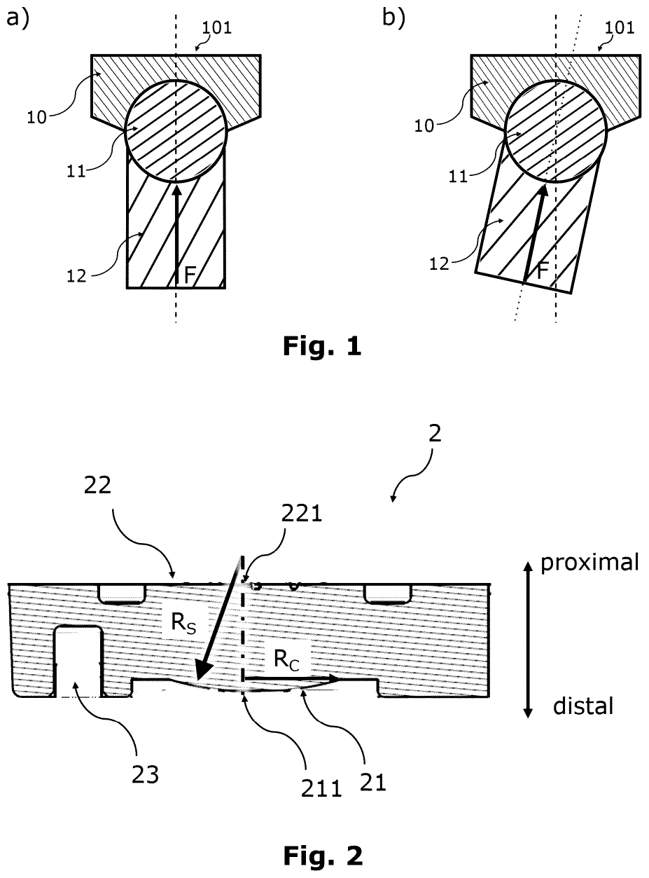

FIG. 1 schematically depicts a state of the art compensation mechanism for a rotor 10 of a shear valve as for example disclosed in US 2011/006237 A1 and WO 2011/008657 A2. The compensation mechanism comprises a ball bearing element 11 disposed between the rotor 10 and a dowel pin 12 that may be press-fit into a corresponding passage at an end of a drive shaft. Both the rotor 10 and the dowel pin 12 comprise respective dome-shaped recesses for receiving a portion of the ball bearing element 11. The rotor 10 further comprises a rotor surface 101 configured to form a sealing interface with a respective stator surface, when pressed against a respective stator. The rotor surface 101 is located opposite to the ball bearing 11 and thus opposite to the compensation mechanism. That is, the ball bearing 11 or more generally the compensation mechanism is located at a side of the rotor 10 that is opposite to the side comprising the rotor surface 101.

During operation of the shear valve, the rotor 10 will be forced against a respective stator, such that the rotor surface 101 and the respective stator surface form a rotor-stator interface also referred to as sealing interface, to provide a substantially fluid tight connection between the rotor surface and the stator surface. In practice, the rotor 10 will be forced against the stator by applying a force through the dowel pin 12.

In FIG. 1 a) a perfectly straight alignment between the dowel pin 12 and the rotor 10 is depicted. In such a case, the force F acts directly along a central axis running through the centre of the rotor 10 (dashed line). However, as discussed above, the manufacturing tolerances or tilting of the rotor relative to the stator can lead to excessive stresses and impede or obviate a substantially liquid-tight relative movement of the rotor with respect to the stator as they would not be guided plane parallel to each other.

Thus, the ball bearing 11 is added as a compensation mechanism which allows the rotor 10 to tilt with respect to the dowel pin 12, such that a relative tilt between stator and rotor can be compensated for as indicated in FIG. 1b). However, such a solution does not only render the respective shear valve more complex due to additional elements required for realising such a compensation mechanism, it also leads to the problem that the point of force application is shifted and no longer in the centre of the rotor surface and thus the sealing interface. This is schematically shown in FIG. 1b) where the force F is applied through the dowel pin 12 as indicated by the dotted line, which no longer coincides with the central, rotation axis of the rotor 10 (dashed line). It can be seen that the point of force application is shifted away from the centre of the rotor surface 1010 (in the depicted example to the right). This may disadvantageously lead to an uneven sealing pressure at the rotor-stator interface which in turn may affect the tightness of said interface and/or the wear and tear of the rotor and/or stator surface, particularly for a hard-on-soft sealing surface. In other words, such a known compensation mechanism may result in one-sided excess stress on the stator and rotor and thus promote premature wear.

Embodiments of the present invention relate to a rotor 2 that comprises a compensating element 21. An exemplary embodiment of such a rotor 2 is depicted in FIG. 2. The rotor 2 comprises a rotor sealing surface 22, also referred to as rotor surface 22, constituting a sealing surface configured to be pressed against a corresponding stator in order to form a stator-rotor interface also referred to as sealing interface. The rotor surface 22 may comprise at least one connecting element, e.g. a groove, configured to selectively fluidly connect or not connect ports of the stator depending on the configuration (i.e. relative position of rotor and stator) assumed by the assembled shear valve. For example, the rotor may comprise 1, 2, 3, 4 or even more grooves.

Generally, the rotor 2 may comprise a proximal and a distal face, wherein the proximal face denotes the face comprising the rotor surface 22 and thus the face that in an assembled state would be more proximal to a stator than for example the compensating element 21. The distal face denotes the face of the rotor 2 that is opposite to the rotor sealing surface and thus more distal to the stator in the assembled state.

The compensating element 21 may be comprised by the distal face of the rotor 2. That is, the compensating element 21 may be located at a face of the rotor that is opposite to the rotor surface. In other words, the rotor surface and the compensating element 21 may be located at opposing sides of the rotor 2.

The compensating element 21 may be integrally formed with other portions of the rotor 2. Preferably, the rotor 2 may be integrally formed. In particular, the rotor surface 22 and the compensating element 21 may be integrally formed as portions of the rotor 2. That is, in contrast to known compensating element, the compensating element 21 according to the current invention is not an additional component, but it is integrated in the rotor 2, e.g., the complete rotor 2 including the compensating element 21 are formed as a single piece. Thus, provision of the compensating element 21 may not require additional parts and therefore reduce the complexity and save costs.

The compensating element 21 may be rotationally symmetric. Furthermore, an element rotation axis of the compensating element 21 may be aligned with a centre of the rotor surface 22. That is, the rotor surface 22 may comprise a rotor sealing surface centre 221 located at the geometrical centre of the rotor surface 22 and the compensating element 21 may be rotationally symmetric with respect to the element rotation axis (dot-dashed line in FIG. 2) that runs through the rotor sealing surface centre 221, preferably perpendicular to the rotor surface 22. More generally, the compensating element 21 may comprise a compensating element centre 211, denoting the geometrical centre of the surface of the compensating element, and the compensating element centre 211 and the rotor sealing surface centre 221 may be aligned. That is, the compensating element centre 211 and the rotor sealing surface centre 211 may lie on a straight line perpendicular to the rotor sealing surface 22.

The compensating element may further comprise an element radius corresponding to half of the maximum extension of the compensating element perpendicular to the element rotation axis. That is, a width of the compensating element may correspond to twice the element radius.

In some embodiments, the compensating element 21 may be dome shaped. For example, the compensating element 21 may take the form of a spherical cap, which may also be referred to as spherical dome or calotte. Generally, a spherical cap is a portion of a sphere or ball cut off by a plane. The spherical cap may comprise a sphere radius R_{S} that describes the curvature of the compensating element. The sphere radius R_{S} may at least amount to the distance between the rotor surface 22 and the most distal point of the compensating element 21, i.e. the spherical cap 21. In other words, the sphere radius R_{S} may be chosen such that the centre of a sphere with the same radius is located at the rotor surface 22 or proximal thereof. In some embodiments, the sphere radius R_{S} may correspond to the distance between the rotor surface 22 and the most distal point of the compensating element 21, i.e. the spherical cap 21. In such an embodiment the point of force application advantageously coincides with the rotor sealing surface centre 221.

In other words, the compensating element may be realized by means of a spherical cap 21 oriented towards the centre of the sealing surface. In this way, the flow of force is guided in the direction of the sealing interface even in the case of tilting from rotor and stator due to manufacturing tolerances. Particularly, the force is guided towards the centre of the sealing interface, i.e. in a direction more closely to the centre of the sealing interface or respectively the rotor sealing surface centre 221.

In embodiments, where the compensating element 21 takes the form of a spherical cap, the element radius may also be referred to as cap radius R_{C}, denoting the radius of a base of the spherical cap, i.e. the radius of a cross section of the spherical cap at its largest extend in a plane parallel to the rotor surface 22 and thus perpendicular to the proximal-to-distal direction. The cap radius R_{C} may be smaller than the sphere radius R_{S}.

The rotor 2 may for example be disk-shaped. The rotor may be made of metal, ceramic, or a polymer. Preferably, the rotor is made of a polymer, e.g. a particle filled polymer.

The rotor 2 may further comprise a plurality of bores 23 or recesses 23 in the distal face, configured to receive a connecting bolt for establishing a connection to a rotor receptacle. That is, very generally the rotor 2 and particularly its compensating element 21 may be received by a rotor receptacle 31 that is connected to the rotor 2 in a rotationally fixed manner. Thus, a rotational force for rotating the rotor 2 relative to a respective stator 32 may be supplied to the rotor by means of the rotor receptacle 31. Further, a force for pressing the rotor against a respective stator, e.g. a compressing force, may be provided via the compensating element 21 comprised by the rotor 2.

In other words, FIG. 2 depicts an embodiment of the rotor 2 with integrated compensating element 21. The compensating element 21 may essentially consist of a spherical cap 21 which is integrated on the side of the rotor 2 facing away from the sealing side, i.e. on the distal face of the rotor 2. The centre of the spherical cap 21 may be located on the centre of the sealing surface or on the extension of the centre towards the stator. In other words, the sphere radius R_{S} may at least amount to the distance between the rotor sealing surface 22 and the most distal point of the compensating element 21, i.e. the centre of the spherical cap 21 denotes the centre of the sphere with sphere radius R_{S}. The spherical cap may be large enough to allow a movement of the rotor 2 in case of a potential tilting of the rotor receptacle or the stator, which compensates for the tilting. The axial transmission of the sealing force may preferably only take place via the spherical cap and not via adjacent surfaces. That is, the axial component of the applied force may preferably be solely transmitted via the spherical cap or more generally the compensating element.

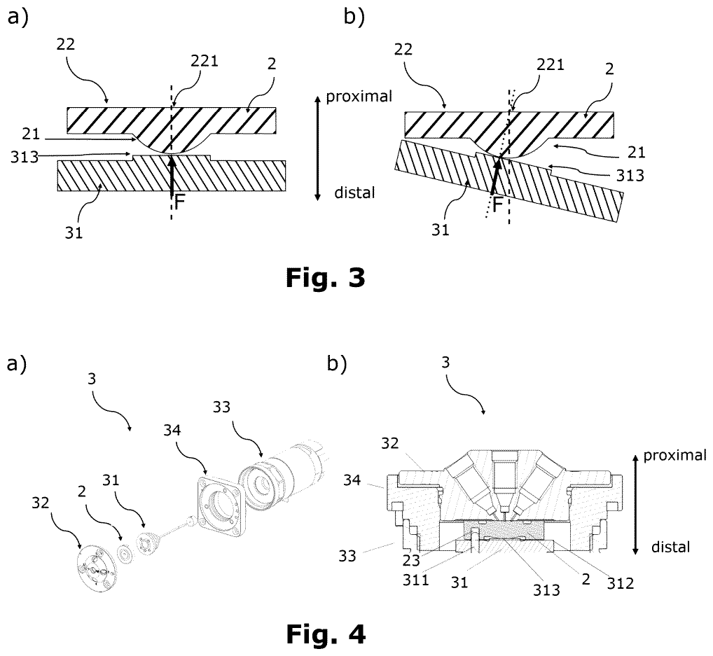

With respect to FIG. 3 a), simplified schematic view of the rotor 2 and a rotor receptacle 31 is discussed. The rotor receptacle 31 may comprise a compensating element contacting portion 313, also referred to as contacting portion 313, configured to contact and interact with the compensating element 21 of the rotor 2. The contacting portion 313 may comprise the most proximal portion of the rotor receptacle 31. That is, at least part of the contacting portion 313 may extend furthest of any portion of the rotor receptacle 31 in the proximal direction. Thus, the contacting portion 313 may be in contact with, i.e. receive, the compensating element 21 of the rotor 2. In other words, the contacting portion 313 may be comprised by a proximal face of the rotor receptacle 31. The contacting portion 313 may protrude from the proximal receptacle face. That is, the contacting portion may be a protrusion of the proximal receptacle face. Preferably, the contacting portion 313 may be surrounded by a groove, channel or indentation in the proximal face of the rotor receptacle 31 (cf. FIG. 4).

The combination of rotor 2 and rotor receptacle 31 may also be referred to as rotor assembly. That is, the rotor assembly may comprise the rotor 2 and the rotor receptacle 31 and may itself be part of the shear valve. That is, the rotor assembly may allow for the rotor to be connected to a drive unit of the shear valve through the rotor receptacle.

The contacting portion 313 may comprise a contacting surface that is part of the most proximal portion of the rotor receptacle 31. The contacting surface and/or the contacting portion may advantageously be circularly shaped. Preferably, the contacting surface may be substantially flat. Further, the contacting portion 313 may comprise a width in a direction perpendicular to the proximal-to-distal direction that is at least equal to the width of the spherical cap 21, i.e. the width of the contacting portion 313 may amount to at least two times the cap Radius R_{C}. In some embodiments, the width may be the same as the width of the spherical cap 21. For example, for a circularly shaped contacting portion 313, the radius of the contacting portion may correspond to the cap Radius R_{C}, respectively the element radius.

Generally, the compensating element 21 and the contacting portion 313 are configured and designed such that a force from the rotor receptacle 31 is transmitted to the rotor 2 via the connection between the contacting portion 313 and the compensating element. Preferably at least 99%, more preferably 99.5% even more preferably 99.9% of the applied force is transmitted via the compensating element. Preferably, the axial force is only transmitted via the connection between the contacting portion 313 and the compensating element. That is, such an axial force may not be transmitted via adjacent surfaces.

FIG. 3 a) depicts rotor 2 and rotor receptacle 31 being perfectly aligned with respect to each other, such that a force F applied through the rotor receptacle 31, e.g. a biasing force supplied by a respective biasing element, is transmitted via the contacting portion 313 that is in contact with the compensating element 21. Consequently, the force F is directed along the rotation axis of the rotor 2 (dashed line) and thus perpendicular to the rotor surface 22. In such an ideal case, the point of force application coincides with the rotor sealing surface centre 221. Thus, the configuration depicted in FIG. 3 a) is comparable to the configuration in FIG. 1 a), with the distinct difference that the compensating element 22 is comprised by the rotor 2.

In contrast, the configuration depicted in FIG. 3 b) is similar to the configuration in FIG. 1 b). That is, there is a relative tilt of rotor 2 and rotor receptacle 31, which is compensated by the compensating element 21 comprised by the rotor 2. In particular, a force F applied to the rotor receptacle 31 is applied to the rotor 2 at an angle with respect to the rotation axis (dashed line), as indicated by the dotted line. However, due to the compensating element 21 comprising a sphere radius R_{S} that corresponds to the thickness of the rotor 2 at the distal most portion of the spherical cap 21, the point of force application advantageously remains at the rotor sealing surface centre 221.

That is, due to the compensating element 21 of the rotor 2, a tilt of the stator 32 and/or rotor receptacle 31 can be compensated for by movement of the rotor 2. Furthermore, in some embodiments, where the sphere radius R_{S} is chosen to match the distance between the centre of the spherical cap 21 and the rotor sealing surface centre 221, i.e. the thickness of the rotor 1 at the spherical cap 21, the present invention advantageously allows for the point of force application to coincide with the rotor sealing surface centre 221.

In other words, a potential tilting of the rotor 2 relative to the stator 32 may advantageously be compensated in such a way that the point of force application is in the centre of the rotor-stator interface, where the axial portion of the applied force acts perpendicular to the rotor-stator interface. This enables a uniform sealing pressure between rotor 2 and stator 32, reduces the stress on the sealing partners (stator and rotor) and optimises service life time. The uniform sealing pressure is advantageous for the tightness of the rotor to stator interface. Furthermore, both the uniform sealing pressure and the reduced stress on rotor and stator advantageously reduced wear and tear of said components, particularly of the rotor sealing surface and the stator sealing surface. This may be particularly advantageous for hard-on-soft sealing surfaces, i.e. embodiments where the rotor sealing surface is made of a soft material such as a polymer.

It will be understood that the relative tilt may typically be in the range of 0° to 2°, at which most of the applied force will act in axial direction, that is the force component acting in axial direction will comprise most of the applied force.

With respect to FIG. 4 an embodiment of a rotary shear valve 3 comprising a rotor 2, or respectively a rotor assembly according to the present invention is discussed, wherein FIG. 4 a) depicts an exploded view of the shear valve and FIG. 4 b) schematically depicts a cross section of the proximal portion of the shear valve 3. The shear valve 3 may generally comprise a rotor 2, a rotor receptacle 31 configured to receive the rotor 2, a stator 32, and a valve drive 33 also referred to as drive unit 33. Further, the shear valve 3 may comprise a fixation means 34 configured for interconnecting components of the shear valve 3, such as a screw-in flange 34.

As discussed, the rotor receptacle 31 is configured to receive the rotor 2. For this purpose, the rotor 2 may comprise a plurality of recesses 23 or bores 23 configured to receive a connecting bolt 311. For example, the rotor may comprise 2, 3, 4 or 5 recesses 23 in its distal face. The rotor receptacle 31 may comprise a proximal receptacle face 312, i.e. the face of the rotor receptacle 31 that is adjacent to the rotor distal face when assembled. Furthermore, the rotor receptacle may comprise corresponding recesses or bores configured to receive the respective connecting bold 311. Thus, the rotor 2 may be rotationally conjointly coupled to the rotor receptacle 31. However, the recesses 23 or bores 23 of the rotor 2 may be configured such that the rotor 2 may tilt by a small but sufficiently large angle, allowing the rotor 2 to compensate any unwanted relative movement between the stator 32 and the rotor. In other words, the rotor 2 may be coupled to the rotor receptacle by means of a plurality of connecting bolts 311 in a rotationally fixed manner with respect to the rotation axis of the shear valve, while at the same time allowing the rotor 2 and thus its rotor surface 22 to perform a tumbling movement through a small but sufficient angular range. For example, a tilt by a polar angle at least in the range of 0° to 1°, preferably at least in the range of 0° to 2° with respect to the rotor receptacle. The polar angle being the angle relative to an axis running through the compensating element centre. In particular, the rotor may be enabled to tilt by any azimuthal angle. In some embodiments, the rotor may be enabled to tilt by a polar angle at least in the range of 0° to 3° or even 0° to 4° with respect to the rotor receptacle.

Again, the rotor receptacle 31 may comprise the compensating element contacting portion 313, also referred to as contacting portion 313, configured to contact and interact with the compensating element 21 of the rotor 2. The contacting portion 313 may comprise the most proximal portion of the rotor receptacle 31 and may preferably be surrounded by a groove, channel or indentation in the proximal face of the rotor receptacle 31, i.e. the proximal receptacle face 312. The contacting portion 313 may comprise a substantially flat and preferably circularly shaped surface that protrudes from the proximal face of the rotor receptacle 31.

The rotor receptacle 31 may be received by the valve drive 33 configured to provide a rotational force to rotate the rotor 2 via the rotor receptacle 31. That is rotor 2 and rotor receptacle may be rotated by means of a rotational force applied to the rotor receptacle 31 by the valve drive 33, wherein rotor and rotor receptacle my conjunctively rotate due to their rotationally fixed coupling. Thus, the rotor may be rotated with respect to the stator by means of providing a rotational force through the drive unit 33.

The valve drive 33 may further be configured to provide an axial force along the rotation axis of the shear valve 3, when the shear valve 3 is in an assembled state. It will be understood that the rotation axis of the shear valve refers to the rotation axis without there being a tilt of the rotor, i.e. when rotor and rotor receptacle assume a relative position as depicted in FIG. 3. Thus, the axial force may also be considered to be applied along the rotation axis of the rotational force provided by the drive unit 33. In other words, the shear valve may be configured to exert an axial force on the rotor configured to press the rotor receptacle and thus the rotor towards the stator. The axial force may be provided through at least one biasing element. In particular, the valve drive 33 may comprise at least one biasing element configured to bias the rotor receptacle 31 and thus the rotor 2 against the stator in the assembled state. The at least one biasing element may for example be a spring element, preferably an annular spring element. The pressing force in the assembled state may be sufficient for HPLC applications. Preferably the biasing element may provide a pressing force on the order of 110% of the operating pressure of the valve.

The stator 32 may generally comprise a stator surface constituting a stator sealing surface configured to receive the rotor surface 22, which may be pressed against the stator sealing surface in order to form a stator-rotor interface also referred to as sealing interface.

Thus, the stator surface may be located on a distal face of the stator, also referred to as distal stator face. Furthermore, the stator 32 may comprise at least two ports. Preferably the ports are provided as fittings for receiving a respective connector, wherein the fittings are also comprised by the stator 32. The ports are fluidly connected to the stator sealing surface, also referred to as stator surface, e.g. through a bore or channel. In other words, the stator surface may comprise respective holes, bores or channels that are each fluidly connected to a port.

Furthermore, the shear valve 3 may comprise a fixation means for interconnecting the different components of the shear valve. The fixation means may be a screw-in flange 34, to which valve drive 33 and stator 32 may be fixedly connected, e.g. through respective threads or by means of screws.

In particular the valve drive 33 may be fixedly attached to a distal side of the screw-in flange 34, i.e. the side that is further away from the stator 32 and thus more distal. The valve drive 33 may for example be screwed to the screw-in flange by means of respective threads of the screw-in flange 34 and the valve drive 33. Subsequently the rotor receptacle 31 may be introduced into the valve drive 33 and the rotor 2 may be placed on the receptacle proximal face 312, such that the connecting bolts 311 engage with the respective recesses 23 or bores 23. Finally, the stator 32 may be placed atop of the rotor 2 such that the stator surface and the rotor surface

In other words, FIG. 4 depicts the basic structure of a shear valve according to the present invention. In particular, it is noted that no additional component is installed to compensate for a tilt of the rotor relative to the stator, e.g. due to manufacturing tolerances. Instead, the compensating element is advantageously integrated in the rotor and received by the rotor receptacle.

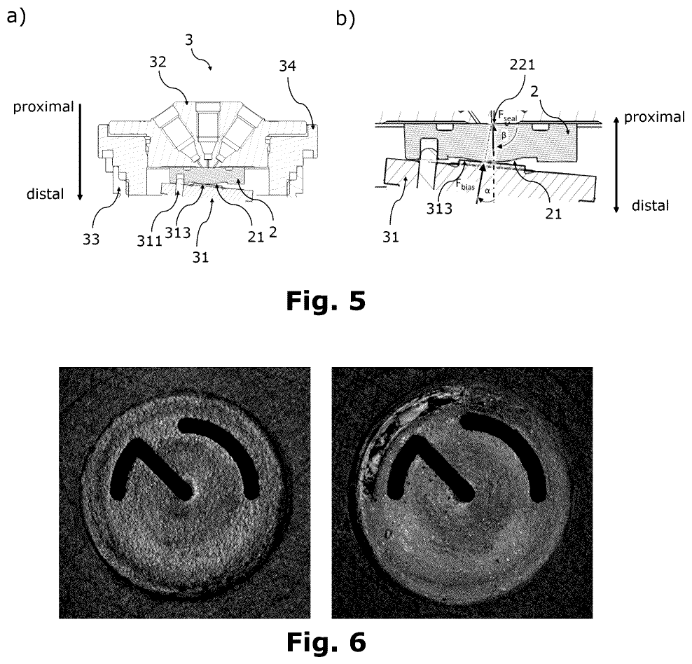

FIG. 5 depicts the cross-sectional view of the proximal portion of the shear valve, wherein the rotor 2 is tilted with respect to the rotor receptacle 31. That is, the receiving portion 313 of the rotor receptacle 31 is in contact with the compensating element 32 of the rotor. However, in contrast to FIG. 4 b), due to the relative tilt between the rotor receptacle 31 and the rotor 2 in FIG. 5 a), the force F_{bias} applied through the rotor receptacle 31 is no longer directed along the rotation axis of the rotor 2. Thus, the force is supplied at an angle with respect to the rotation axis of the rotor. That is, FIG. 5 depicts the shear valve with the rotor 2 and rotor receptacle 31 in a position similar to FIG. 3 b).

Again, the rotationally fixed coupling of rotor 2 and rotor receptacle 31 is configured such that it allows for the rotor to tilt with respect 2 to the rotor receptacle 31.

FIG. 5 b) depicts a detailed view of the interface between the rotor 2 and the rotor receptacle 31 with a relative tilt with respect to the rotation axis of the rotor 2 (dash-dotted line). The depicted configuration generally corresponds to the configuration depicted in the simplified view of FIG. 3 b). That is, there is a relative tilt of the rotor 2 and the rotor receptacle 31, which is compensated by the compensating element 21 comprised by the rotor 2.

The force F_{bias} applied at an angle α with respect to a rotation axis of the rotor sealing surface, i.e. the surface rotation axis, is transmitted from the rotor receptacle 31 to the rotor 2 via the contacting portion 313 and the compensating element 21. Due to the curvature of the compensating element 21, the force F_{bias} is directed towards the rotor sealing surface centre 221. In the depicted embodiment, the Force F_{bias} is directed to the rotor sealing surface centre 221 due to the choice of the sphere radius R_{S}. That is, the curvature of the compensating element 21, which in the case of the depicted spherical cap 21 is defined through the sphere radius R_{S}, may be chosen such that it directs the force to the rotor sealing surface centre. For example, R_{S} may be chosen to correspond to the thickness of the rotor at the centre of the compensating element 21. The force F_{bias} may for example be provided by means of a biasing element, such as a spring element that acts on the rotor receptacle 31.

Having the force being directed to the rotor sealing surface centre may be advantageous, as this may be the section where sealing is most important compared to other, more peripheral sections. Furthermore, by having the force centred, a more uniform stress distribution of the rotor may be achieved, thereby increasing service life.

Furthermore, due to the small tilting angle, which may typically lie in the range of 0° to 2°, most of the biasing force F_{bias} may act in axial direction as sealing force Fₛₑₐₗ. For example at a tilting angle of α=2°, the sealing force would amount to Fₛₑₐₗ=cos(α)×F_{bias}=0.9994 F_{bias}.

In other words, FIG. 5 depicts the working principle of the integrated compensating element 21 when tilted. It should be noted that the point of application of the force acts centrally on the rotor sealing surface 22 even in the case of tilting. That is, the centre of the rotor sealing surface, i.e. the rotor sealing surface centre 221 and the point of application of the force advantageously coincide. Alternatively, if the sphere Radius R_{S} is chosen to be greater than the width of the rotor, the point of force application is at least closer to the rotor sealing surface centre.

Again, the present invention may have a number of advantages in view of the known state of the art. Firstly, it does not require any additional component for providing a compensating mechanism. Instead, the compensating element is part of the rotor. Since the rotor is a wearing part that is replaced at regular intervals, the compensating element is always replaced at the same time. Therefore, ageing and wear of the compensating element may not be relevant to the performance of the valve. Particularly, there is no need to regularly replace the compensating element in addition to the rotor, which is anyway regularly replaced. Thus, advantageously providing a reduced maintenance effort for the valve. Yet further, manufacturing costs for the compensating element and potential additional compensating-mechanism components is reduced or even eliminated, as the compensating element is part of the rotor. Finally, the present invention advantageously may allow for the sealing force to act vertically and centrally on the sealing surface. In this way, the sealing force may be highly effective. Consequently, the sealing force may be evenly distributed and one-sided wear may be reduced.

The effect of the present invention can also be seen in FIG. 6 depicting a rotor according to the present invention on the left panel and a rotor without a compensating element on the right panel. Both rotors have been deliberately tilted and it can be seen that the rotor according to the present invention experienced a significantly reduced wear.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. A rotor for a rotary shear valve, the rotor comprising
a rotor sealing surface, and
a compensating element.

2. The rotor according to claim 1, wherein the compensating element is permanently connected to at least one other portion of the rotor.

3. The rotor according to claim 1, wherein the compensating element comprises the form of a spherical cap, wherein the spherical cap comprises a sphere radius that describes a curvature of the compensating element.

4. The rotor according to claim 3, wherein the sphere radius amounts at least to a distance between the rotor sealing surface and the most distal point of the compensating element.

5. The rotor according to claim 1, wherein the compensating element comprises an element surface roughness of at most 1 μm Ra.

6. The rotor according to claim 5, wherein the compensating element comprises an element surface roughness of at most 0.6 μm Ra.

7. (canceled)

8. The rotor according to claim 1, wherein the rotor is configured for pressures of at least up to 100 bar.

9. The rotor according to claim 8, wherein the rotor is configured for pressures at least up to 500 bar.

10. The rotor according to claim 9, wherein the rotor is configured for pressures at least up to 1500 bar.

11. A rotor assembly for a rotary shear valve, the rotor assembly comprising
a rotor comprising a rotor sealing surface and a compensating element, and
a rotor receptacle configured to receive the rotor,
wherein the rotor is connected to the rotor receptacle in a rotationally fixed manner.

12. The rotor assembly according to claim 11, wherein the rotor receptacle comprises a contacting portion, configured to contact and interact with the compensating element of the rotor.

13. The rotor assembly according to claim 11, wherein the rotor assembly is configured to receive a force at the rotor receptacle and direct the force to the rotor sealing surface via the contacting portion and the compensating element.

14. The rotor assembly according to claim 11, wherein the rotor assembly is configured to enable the rotor to tilt with respect to the rotor receptacle.

15. The rotor assembly according to 14, wherein the rotor is enabled to tilt by a polar angle at least in the range of 0° to 1° with respect to the rotor receptacle.

16. The rotor assembly according to 15, wherein the rotor is enabled to tilt by a polar angle at least in the range of 0° to 2° with respect to the rotor receptacle.

17. A rotary shear valve comprising
a rotor comprising a compensating element,
a rotor receptacle configured to receive the rotor,
a stator, and
a drive unit.

18. The valve according to claim 17, wherein the valve is configured for an operating pressure of at least up to 100 bar.

19. (canceled)

20. (canceled)

21. The valve according to claim 17, wherein the rotor comprises a rotor sealing surface and a compensating element.

22. The valve according to claim 17, wherein the rotor and the rotor receptacle are comprised by a rotor assembly,
wherein the rotor comprises a rotor sealing surface and a compensating element, and
wherein the rotor is connected to the rotor receptacle in a rotationally fixed manner.

23. The valve according to claim 17, wherein the valve is configured to assume different configurations, wherein for each different configuration the relative position of stator and rotor differs.
